(19) United States
(12) Patent Application Publication
(10) Pub. No.: US 2017/0229835 A1
(43) Pub. Date: Aug. 10, 2017

(54) LASER AMPLIFIER

(71) Applicant: JGM Associates, Inc., Burlington, MA (US)

(72) Inventor: Jeffrey G. Manni, Burlington, MA (US)

(73) Assignee: JGM Associates, Inc.

(21) Appl. No.: 15/098,554

(22) Filed: Apr. 14, 2016

Related U.S. Application Data
(60) Provisional application No. 62/293,365, filed on Feb. 10, 2016.

(51) Int. Cl. H01S 3/08; H01S 3/0941; H01S 3/16; H01S 3/06

(52) U.S. Cl. CPC H01S 3/08095; H01S 3/0625; H01S 3/0941; H01S 3/0606; H01S 3/1618; H01S 2301/02

(57) ABSTRACT

A laser amplifier includes a broadband laser gain medium having a first lateral face spaced from an opposing second lateral face at a wedge angle with respect to the first lateral face. At least the first lateral face receives a pump beam and one of the first and second lateral faces receives a seed beam. A first coating on the first lateral face is highly transmissive at the pump beam wavelength. A second coating is disposed on the second lateral face. In one example, the first coating is highly reflective at the seed beam wavelength over a first wavelength band and the second coating is highly reflective at the seed beam wavelength over a second wavelength band (partially or fully) overlapping the first wavelength band.

### RELATED APPLICATIONS

This application claims benefit of and priority to U.S. Provisional Application Ser. No. 62/293,365 filed Feb. 10, 2016, under 35 U.S.C. §§119, 120, 363, 365, and 37 C.F.R. §1.55 and §1.78, which is incorporated herein by this reference.

### FIELD OF INVENTION

The subject invention relates to laser amplifiers.

### BACKGROUND OF THE INVENTION

A diode pumped laser amplifier typically includes a laser gain medium pumped by a diode laser beam or beams to amplify an incident or seed laser beam.

In one design, a diode-pumped laser amplifier (“VHGM” amplifier) employs a zig-zag beam path through a wedged amplifier slab designed to suppress build-up of amplified spontaneous emission (ASE) that would otherwise act to prevent high laser gain. See U.S. Pat. No. 7,590,160 incorporated herein by this reference by the assignee hereof. The zig-zag path of the beam being amplified is configured by injecting the seed beam into the amplifier slab so it makes multiple bounces off the lateral sides of the slab having a wedge angle between them (on the order of one or a few degrees). The lateral sides of the slab have thin-film dielectric (quarter-wave) coatings on them designed to be highly reflecting (HR) at the seed laser wavelength and highly transmitting (HT) at the diode-pump wavelength. Long gain lengths in the slab are achieved by injecting the seed beam so it makes five or more bounces on each side (for example) and therefore 10 or more passes across the width of the amplifier slab. In this example, if the slab width is 5 mm, then the zig-gain length through the slab is >50 mm and is much longer than physical length of the slab (e.g., 15 mm). With a suitable gain medium such as Nd:YAG or Nd:YVO₄, the long zig-zag gain length can result in amplifier gain of 10⁴ to 10⁵.

Usually, the HR coatings on the lateral sides of the VHGM slab are identical. That is, they have the same center wavelength and the same spectral bandwidth. When using Nd-doped laser materials, which typically have gain bandwidths of 0.5 to 1.5 nm, the HR coating bandwidth is usually much wider (50 nm or more) than the gain bandwidth of the laser material.

Other laser gain materials may be desired. Ytterbium-doped (Yb-doped) laser glasses and crystals are of interest because Yb-doped gain media typically have gain bandwidths much larger than Nd-doped materials and these large bandwidths are useful for making wavelength-tunable lasers and for making lasers and amplifiers that can generate ultrashort pulses in the femtosecond to picosecond range. For example, a gain bandwidth of about 15 nm is need to make laser amplifiers that can amplify 100 femtosecond pulses without having the amplifier broaden the temporal pulse to something longer than 100 femtoseconds. Such ultrashort pulses are useful in industrial laser systems, for example, for drilling without generating too much heat.

However, in some laser design situations, the gain bandwidth provided by Yb-doped and other broad-bandwidth materials can be too large. The result can be spurious lasing or ASE build-up at wavelengths other than the wavelengths to be amplified which usually results in degraded amplifier or laser performance at the desired wavelengths.

### SUMMARY OF THE INVENTION

Limiting the “effective” gain bandwidth of the amplifier, as discussed below, can prevent ASE at undesired wavelengths outside the intended or desired wavelength range. Reduced gain bandwidths might also reduce unwanted ASE build-up that occurs at the same wavelengths to be amplified. Also, for an ASE source (no injected seed beam), an adjustable gain bandwidth provides a means to control the output spectrum and power of the ASE source.

The invention includes a method to suppress laser emission at undesired wavelengths in a laser material having a broad gain bandwidth. In the VHGM design, the two sides of the slab that establish the zig-zag beam path preferably have a thin-film optical coating that is highly reflecting (HR) at the seed laser beam wavelength (wavelengths to be amplified) and highly transmitting (HT) at the diode-pump wavelengths (on one or both sides of the slab). Previously, the coatings on the two slab sides were designed to be HR over the same wavelength range.

Provided is a diode-pumped laser amplifier having an effective gain bandwidth substantially narrower than the gain bandwidth of the laser material used to make the amplifier. In one example, the effective gain bandwidth can be tailored according to the needs of specific laser amplifier design situations. The center wavelength and spectral width of the effective gain bandwidth can be located anywhere within the gain bandwidth of the laser material as needed to provide laser gain at desired wavelengths and suppress significant light amplification and emission at unwanted wavelengths. The center wavelength and spectral width of the effective gain bandwidth can be tailored to provide laser gain at desired wavelengths and suppress amplified spontaneous emission (ASE) at or near the desired wavelengths and suppress ASE that might otherwise occur at unwanted wavelengths substantially different than the desired wavelengths.

Featured is a laser amplifier comprising a broad bandwidth laser active material having a first lateral face spaced from a second lateral face with at least the first lateral face receiving at least one pump beam and one of the first and second lateral faces receiving a seed beam. A first coating is associated with the first lateral face and is highly reflective at the seed beam wavelength and highly transmissive at the pump beam wavelength. A second coating is associated with the second lateral face and is highly reflective at the seed beam wavelength. The first and second coatings are configured to provide gain of the seed beam over a narrower wavelength than the gain bandwidth of the laser active material.

In one example, the first lateral face is at a wedge angle with respect to the second lateral face. The first coating is on at least a portion of the first lateral face and the second coating is on at least a portion of the second lateral face. In other examples, the first lateral face is parallel to the second lateral face and the first coating is orientated at a wedge angle with respect to the second coating.

In one embodiment, the coating is highly reflective over a broad wavelength band and the second coating is also highly reflective over a different broad wavelength band which overlaps the broad wavelength band of the first coating. The laser active material broad wavelength bandwidth may be 100 nm or greater, the broad wavelength band of the first and second coatings may be 80 nm or greater, and the overlapping wavelength region may be between 5 nm and 50 nm.

In another embodiment, the first and second coatings are highly reflective over a wavelength band narrower than the bandwidth of the laser active material, e.g., the narrow wavelength band is 3-10 nm.

The broad bandwidth laser active material may be Yb, Tm, Cr, Er, and/or Ho-doped gain materials.

Also featured is a laser amplifier comprising a broadband laser gain medium having a first lateral face spaced from an opposing second lateral face at a wedge angle with respect to the first lateral face. At least the first lateral face receives a pump beam and one of the first and second lateral faces receive a seed beam. A first coating on the first lateral face is highly transmissive at the pump beam wavelength. A second coating is disposed on the second lateral face. The first coating is highly reflective at the seed beam wavelength over a first wavelength band and the second coating is highly reflective at the seed beam wavelength over a second wavelength band overlapping said first wavelength band.

Also featured is a laser amplifier comprising a broad bandwidth laser gain medium having a first lateral face spaced from an opposing second lateral face at a wedge angle with respect to the first lateral face. The first lateral face receives a pump beam and at least one of the first and second lateral faces receives a seed beam. A first coating on the first lateral face is highly transmissive at the pump beam wavelength. A second coating is disposed on the second lateral face. The first coating is highly reflective at the seed beam wavelength only over a first wavelength band between 3-10 nm and the second coating highly reflective at the seed beam wavelength only over a second wavelength band between 3-10 nm.

Also featured is an ASE source comprising a broad bandwidth laser active material having a first lateral face spaced from a second lateral face with at least the first lateral face receiving at least one pump beam creating ASE. A first coating is associated with the first lateral face and is highly reflective at the ASE wavelength and highly transmissive at the pump beam wavelength. A second coating is associated with the second lateral face and is highly reflective ASE wavelength. The first and second coatings are configured to provide gain of the ASE over a narrower wavelength than the gain bandwidth of the laser active material.

Also featured is a laser seed beam amplification method comprising choosing a broad bandwidth laser active material having a first lateral face spaced from a second lateral face. At least one pump beam is directed at the first lateral face. A seed beam is directed at one of the first and second lateral faces. The method further includes employing a first coating associated with the first lateral face highly reflective at the seed beam wavelength and highly transmissive at the pump beam wavelength and employing a second coating associated with the second lateral face highly reflective at the seed beam wavelength. The first and second coatings are configured to provide gain of the seed beam over a narrower wavelength than the gain bandwidth of the laser active material.

In one example, the first coating is designed to be highly reflective over a broad wavelength band and the second coating is designed to be highly reflective over a different broad wavelength band overlapping the broad wavelength band of the first coating. For example, the laser active material broad wavelength bandwidth can be chosen to be 100 nm or greater and the broad wavelength band of the first and second coatings can be designed to be 80 nm or greater wherein the overlapping wavelength region is designed to be between 5 nm and 50 nm.

In another example, the first and second coatings are designed to be highly reflective over a wavelength band narrower than the bandwidth of the laser active material. For example, the narrow wavelength band can be 3-10 nm.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of an example of a laser amplifier in accordance with the subject invention;

FIG. 2A is a graph showing the reflectivity of the lateral face coatings shown in FIG. 1 over different wavelength bands;

FIG. 2B is a graph similar to FIG. 2A but now the reflectivity wavelength bands overlap over a narrower wavelength region;

FIG. 3 shows the effective gain bandwidth for a Yb-doped gain medium and the spectral overlap of the highly reflective coatings;

FIG. 4 is a graph showing reflectivity vs. wavelength when the lateral side thin film dielectric coatings of FIG. 1 are chosen to be the same or similar but have a narrow high reflectivity bandwidth;

FIG. 5 is a graph showing gain vs. wavelength for a Yb-doped gain medium;

FIG. 6 is a top schematic view showing another example of a laser amplifier in accordance with this invention; and

FIG. 7 is a top schematic view showing another example of a laser amplifier.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

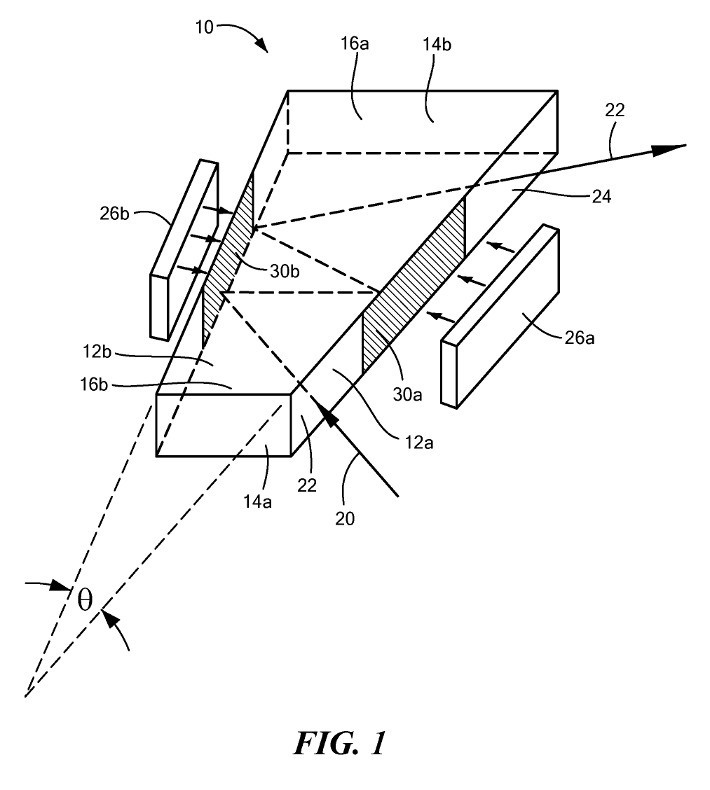

As shown in FIG. 1, broadband laser active or gain material slab 10 has a first lateral face 12a opposing the second space lateral face 12b with a wedge angle θ between faces 12a and 12b (exaggerated in FIG. 1). Slab 10 also includes opposing longitudinal faces 14a and 14b and opposing transverse faces 16a and 16b. Coatings 30a and 30b (e.g., thin film dielectric coatings) are highly reflective at the seed beam wavelength (e.g., 1064 nm) and highly transmissive at the pump beam wavelength (e.g., 808 nm or 976 nm.

As discussed in U.S. Pat. No. 7,590,160 incorporated herein by this reference, seed or input laser beam 20 (e.g., 1064 nm) enters window 22 and the resulting amplified beam 22 exits window 24 after seed beam 20 reflects off lateral faces 20a, 20b due to coatings 30a and 30b. Diode laser bars 26a and/or 26b in conjunction with the gain medium 10 amplify the incident laser beam. If only diode bar 26a is used, coating 30b is highly reflective at the seed beam wavelength and highly transmissive at the diode pump wavelength or may be highly reflective at the diode pump wavelength to achieve 2-pass pumping of the gain medium.

In one example, there is a need to amplify femtosecond or picosecond laser pulses (sub-picosecond or ultrashort pulses) at 1064 nm using readily available broad-gain-bandwidth laser materials.

Basic Fourier-Transform math/physics dictates that the numerical product of laser pulse duration and spectral bandwidth is nominally equal to or greater than a constant approximately equal to one. That is,

Δν*Δt≧“1”, (1)

where Δν is the frequency bandwidth of the laser emission and Δt is the temporal pulse duration. The actual value of “1” depends on various factors such as the shape of the pulse and spectrum, among other factors. As an example, a 100 femtosecond (fs) pulse must have a spectral bandwidth at least 14.6 nm wide, and a 10 fs pulse must have spectral bandwidth at least 146 nm wide. A pulse is said to be Fourier-transform-limited or just “transform-limited” when the spectral bandwidth of the pulsed laser emission has the minimum value allowed for the laser pulse duration in question.

The larger the spectral bandwidth of the laser pulse to be amplified, the larger the amplifier's gain bandwidth must be. So, in the above example, if one wants to amplify 100 fs pulses, the amplifier gain bandwidth must be at least 14.6 nm wide.

For a number of reasons, the laser system design may constrain the ultrashort-pulse seed wavelength to wavelengths at or near 1064 nm, or to some other preferred wavelength, that cannot be matched easily to gain peaks of readily available broad-bandwidth laser materials. Many Nd-doped laser materials have maximum gain peaks at or around 1064 nm but gain bandwidths are in the range of 0.5 to 1.5 nm and are not suitable for amplifying sub-picosecond pulses.

Yb-doped laser materials typically have very broad gain bandwidths centered somewhere in the 1000 nm to 1100 nm range and have gain bandwidths of 20 nm to more than 100 nm. Some gain materials can potentially be used to amplify ultrashort pulses with 1064 nm center wavelengths. However, most Yb-doped materials have maximum gain peaks centered at wavelengths well away from 1064 nm. ASE build-up at these peak gain wavelengths can (and often does) compete with laser amplification at 1064 nm such that amplifier gain at 1064 nm is reduced or prevented.

When the gain medium has a broad bandwidth (e.g., approximately 15 nm or greater) because it is made of Yb, Tm, or Ho-doped crystalline material, for example, the result can be spurious lasing or amplified spontaneous emission (ASE) at wavelengths other than the wavelengths sought to be amplified (e.g., 1064 nm). The result can be degraded amplifier performance.

Accordingly, in the subject invention, lateral face coatings 30a, 30b are configured to provide gain of the seed beam 20 over a narrower wavelength band (e.g., 3-10 nm) than the gain bandwidth of the laser active material (e.g., 100 nm).

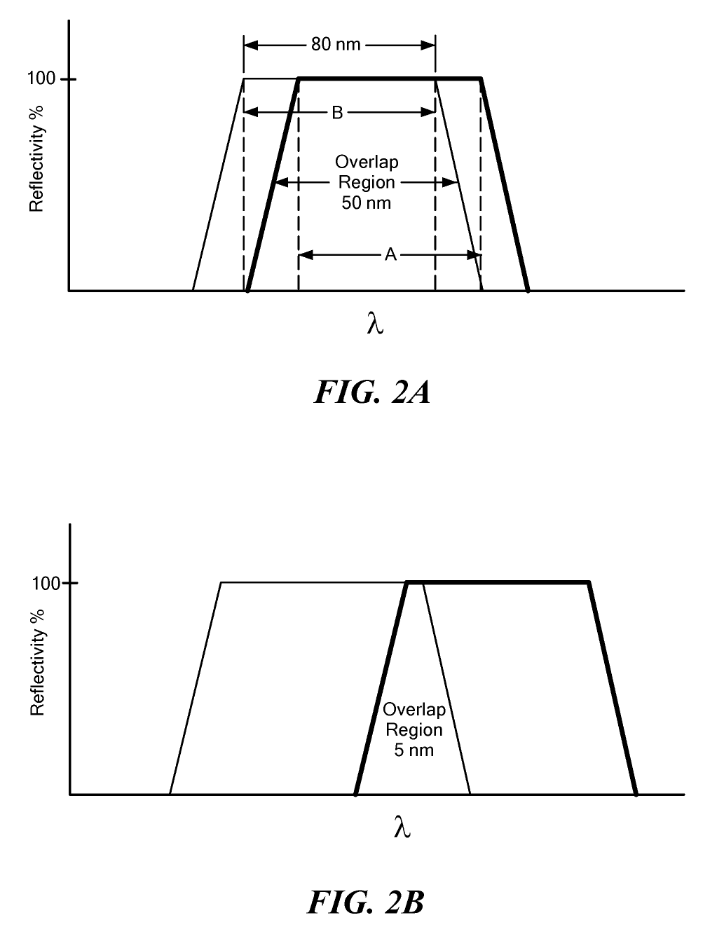

In one example, the coatings 30a, 30b are both highly reflective (e.g., near 100%) over a broad wavelength band (e.g., 80 nm or greater and close to the gain bandwidth of the laser medium) but are designed so that the first and second coating highly reflective wavelength bands overlap (partially or fully) as shown in FIG. 2. In FIG. 2A, coating 30a, FIG. 1 is highly reflective at the seed beam wavelength over a broad bandwidth A and coating 30b is highly reflective at the seed beam wavelength over a different broad bandwidth B which overlaps broad bandwidth A. The overlap may be approximately 50 nm or narrower, as shown in FIG. 2B, (e.g., approximately 5 nm).

As a result, only the wavelengths that fall within the spectral overlap region of the two coatings pass through in a zig-zag fashion through the gain medium to achieve long gain length and a high gain.

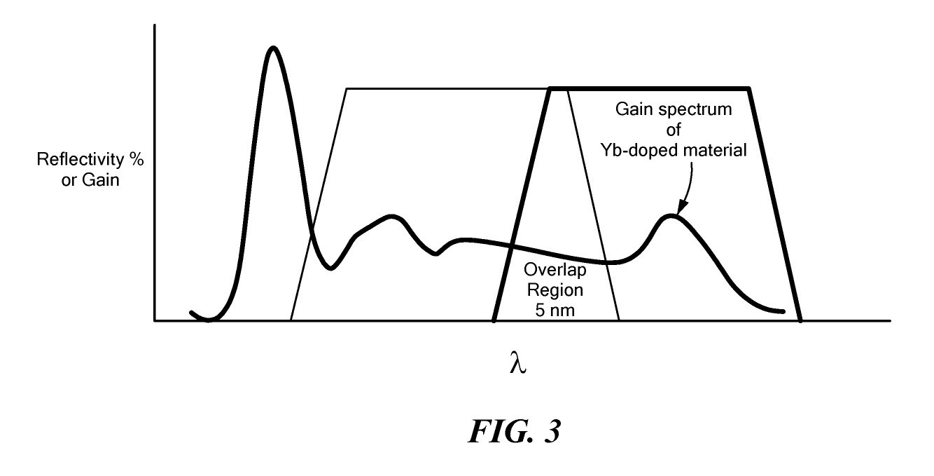

FIG. 3 shows how the spectral overlap region of the two coatings overlap the gain spectrum of a Yb-doped or other broad-gain-bandwidth laser material. The wavelengths that fall within the gain spectrum of the Yb-doped material and at the same time within the spectral overlap region of the two lateral face coatings determine the effective gain spectrum of the coated amplifier slab. Only wavelengths in the effective gain bandwidth can achieve the desired level of high gain in the laser amplifier.

The modified HR coatings on the two slab sides have different center wavelengths and/or bandwidths so that they partially overlap in wavelength space. The thin-film coatings can designed and deposited on the slab lateral sides to give any desired overlap range down to some minimum overlap (as small as a few nanometers) determined by the coating technology being used, the coating materials and design, the laser material, and other factors.

Tailoring of the effective gain spectrum can thus be accomplished according to the needs of specific laser amplifier design situations. Such tailoring cannot be accomplished in an optical fiber amplifier (which relies on total internal reflection to guide the seed beam in the fiber) nor in bulk-solid-state amplifiers in which the seed beam passes straight through the gain medium, and not in other bulk-solid-state amplifier designs that rely on total internal reflection to configure a zig-zag beam path through the amplifier slab.

The center wavelength of the effective gain bandwidth is preferably located at one of the gain peaks of the laser material in order to maximize amplifier gain. The effective gain bandwidth is made as narrow as is consistent with desired seed beam amplification while at the same minimizing the amount of spontaneous emission power that can contribute to ASE build-up.

The center wavelength of the effective gain bandwidth may be centered at some desired wavelength not at one of laser medium's gain peaks as may be dictated by available seed laser wavelengths for example. The effective gain bandwidth of the amplifier is made narrow enough to prevent ASE build-up at gain peaks of the laser medium when amplifying the desired seed wavelength. Making the bandwidth even narrower might also reduce ASE build-up at the seed wavelength.

The HR center wavelengths may be positioned and the bandwidth is adjusted to overlap with a relatively flat portion of the laser medium's gain curve (where there are no local gain peaks) to achieve so-called “gain flattening” of the amplifier stage. See FIG. 3.

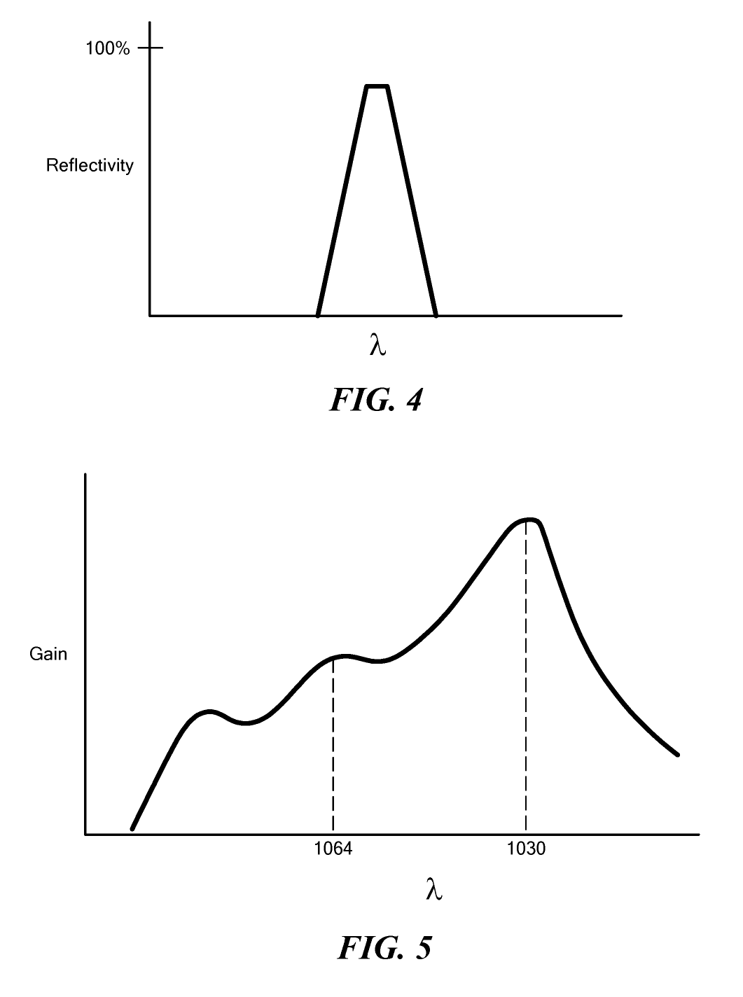

In another example shown in FIG. 4, the first and second coatings are the same or similar and highly reflective at the seed beam wavelength over only a narrow bandwidth (e.g., 3-10 nm) substantially less than the gain bandwidth of the laser medium. The result is the same in that the wavelengths that fall within the gain spectrum of the Yb-doped material and at the same time within the narrow bandwidth region of the two coatings determine the effective gain spectrum of the coated amplifier slab and only wavelengths in the effective gain bandwidth can achieve the desired level of high gain in the laser amplifier.

In this embodiment of the invention, the lateral surfaces of the VHGM amplifier have identical HR coatings (same center wavelength and bandwidths), but the HR bandwidth is substantially less than the gain bandwidth of the laser gain medium. The center wavelength of the HR coatings is located relative to the gain peak(s) of the laser gain medium in some useful way. As an example, if an HR center wavelength of 1064 nm is desired an HR bandwidth of 20 is chosen so 100 fs pulses can be amplified while suppressing ASE in Yb-doped materials with gain peaks at 1020 or 1030 nm.

For a standard multilayer dielectric HR “stack” having multiple quarter-wave optical thickness (QWOT) layers, the HR bandwidth is determined according to (Macleod, Thin Film Optical Filters):

$$Δ g = \frac{2}{π} {sin}^{- 1} ( \frac{{n}_{H} - {n}_{L}}{{n}_{H} + {n}_{L}} ) . \qquad ( 2 )$$

where n_{H} is the refractive index of the high-index material used to make the dielectric QWOT stack and n_{L} is the refractive index of the low-index material. Here Δg=Δν (cm⁻¹)/ν₀ (cm⁻¹) and ν₀ is the center frequency of the HR bandwidth expressed in wavenumbers (cm⁻¹). The HR bandwidth is determined only by the refractive indices of the materials used to make the QWOT stack. As an example, if ν₀ is 10,000 cm⁻¹ (which corresponds to a wavelength of 1000 nm), then, for typical materials used to make HR coatings at 1000 nm, Δg values of 0.05 to 0.10 and HR bandwidths of 500 to 1000 cm⁻¹ (50 to 100 nm) are the norm. Much narrower HR bandwidths might be achieved using sophisticated multilayer designs, but they could be costly and may not have adequate damage thresholds for use in high power laser amplifiers.

FIG. 5 shows the gain of a Yb-doped laser gain medium. By tailoring the lateral face coatings as described above the output amplified beam will be at 1064 nm and the ASE at 1030 and other wavelengths will be suppressed.

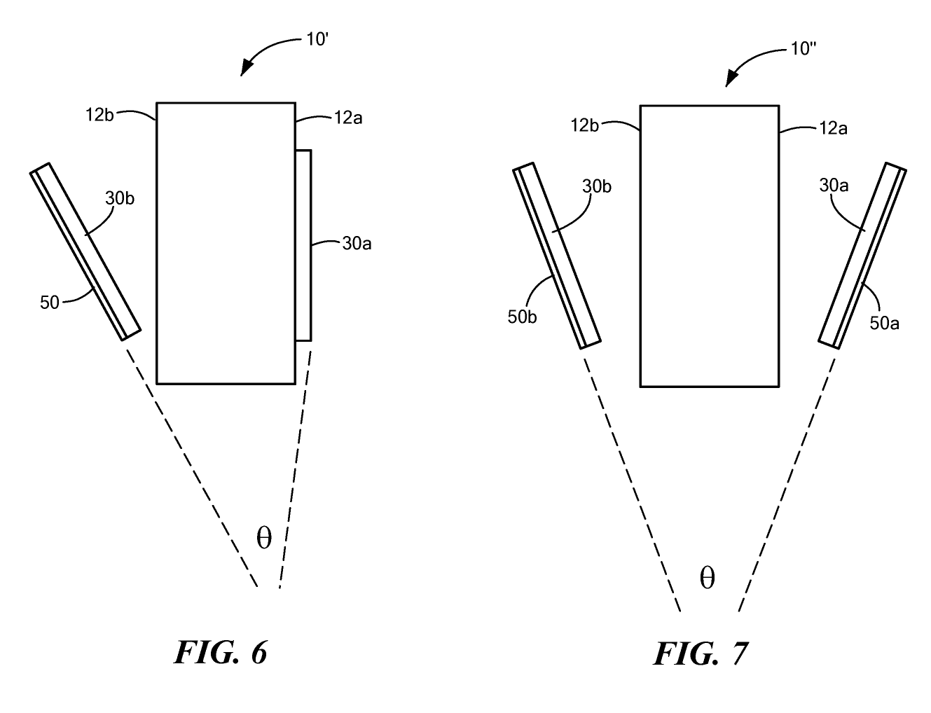

In the design of FIG. 6, the laser gain medium 10′ is rectangular in shape and lateral faces 12a and 12b are parallel. Coating 30a is deposited on lateral face 12a and coating 30b is disposed on another substrate 50 located adjacent lateral face 12b and disposed at a wedge angle θ (shown exaggerated) with respect to coating 30a. In the design of FIG. 7, both coatings 30a and 30b are angled relative to lateral faces 12a and 12b.

Amplifiers with tailored gain bandwidths can also be used advantageously with cw seed laser beams as well as pulsed nanosecond, picosecond, and femtosecond lasers. All of these might benefit from an ability to suppress gain at unwanted wavelengths, and possible reduction of ASE at or near the seed wavelength.

Other broad gain bandwidth laser materials that can be considered for use in VHGM amplifiers include Cr-doped materials (for amplifying 1300-1500 nm wavelengths), Er-doped materials (1500 to 1700 nm wavelengths), and Tm-doped materials (1800 to 2000 nm) and Ho doped materials (1900-210 nm). The invention can be applied usefully for VHGM amplifiers that employ any of these materials.

Also, an ASE source (no injected seed beam) can be made using the invention as an adjustable gain bandwidth provides a means to control the center wavelength, emission bandwidth, and output power of the ASE source. In such an ASE source, the lateral face coatings are chosen to be highly reflective at the ASE wavelength.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A laser amplifier comprising:
a broad bandwidth laser active material having a first lateral face spaced from a second lateral face with at least the first lateral face receiving at least one pump beam and one of the first and second lateral faces receiving a seed beam;
a first coating associated with the first lateral face highly reflective at the seed beam wavelength and highly transmissive at the pump beam wavelength;
a second coating associated with the second lateral face highly reflective at the seed beam wavelength; and
the first and second coatings configured to provide gain of the seed beam over a narrower wavelength than the gain bandwidth of the laser active material.

2. The laser amplifier of claim 1 in which the first lateral face is at a wedge angle with respect to the second lateral face, the first coating is on at least a portion of the first lateral face, and the second coating is on at least a portion of the second lateral face.

3. The laser amplifier of claim 1 in which the first lateral face is parallel to the second lateral face and the first coating is orientated at a wedge angle with respect to the second coating.

4. The laser amplifier of claim 1 in which the first coating is highly reflective over a broad wavelength band and the second coating is highly reflective over a different broad wavelength band overlapping the broad wavelength band of the first coating.

5. The laser amplifier of claim 4 in which the laser active material broad wavelength bandwidth is 100 nm or greater.

6. The laser amplifier of claim 5 in which the broad wavelength band of the first and second coatings is 80 nm or greater.

7. The laser amplifier of claim 6 in which the overlapping wavelength region is between 5 nm and 50 nm.

8. The laser amplifier of claim 1 in which the first and second coatings are highly reflective over a wavelength band narrower than the bandwidth of the laser active material.

9. The laser amplifier of claim 8 in which the narrow wavelength band is 3-10 nm.

10. The laser amplifier of claim 1 in which the broad bandwidth laser active material is Yb, Tm, Cr, Er, and/or Ho-doped gain materials.

11. A laser amplifier comprising:
a broadband laser gain medium having a first lateral face spaced from an opposing second lateral face at a wedge angle with respect to the first lateral face, at least the first lateral face receiving a pump beam and one of the first and second lateral faces receiving a seed beam;
a first coating on the first lateral face highly transmissive at the pump beam wavelength;
a second coating on the second lateral face;
the first coating highly reflective at the seed beam wavelength over a first wavelength band; and
the second coating highly reflective at the seed beam wavelength over a second wavelength band overlapping said first wavelength band.

12. The laser amplifier of claim 11 in which the laser gain medium broad wavelength band is 100 nm or greater.

13. The laser amplifier of claim 12 in which the overlapping wavelength region is between 5 nm and 50 nm.

14. The laser amplifier of claim 11 in which the broad bandwidth laser gain material is Yb, Tm, Cr, Er, and/or Ho-doped gain materials.

15. A laser amplifier comprising:
a broad bandwidth laser gain medium having a first lateral face spaced from an opposing second lateral face at a wedge angle with respect to the first lateral face, the first lateral face receiving a pump beam and at least one of the first and second lateral faces receiving a seed beam;
a first coating on the first lateral face highly transmissive at the pump beam wavelength;
a second coating on the second lateral face;
the first coating highly reflective at the seed beam wavelength only over a first wavelength band between 3-10 nm; and
the second coating highly reflective at the seed beam wavelength only over a second wavelength band between 3-10 nm.

16. The laser amplifier of claim 15 in which the broad bandwidth laser active material is Yb, Tm, Cr, Er, and/or Ho-doped gain materials.

17. An ASE source comprising:
a broad bandwidth laser active material having a first lateral face spaced from a second lateral face with at least the first lateral face receiving at least one pump beam creating ASE;
a first coating associated with the first lateral face highly reflective at the ASE wavelength and highly transmissive at the pump beam wavelength;
a second coating associated with the second lateral face highly reflective ASE wavelength; and
the first and second coatings configured to provide gain of the ASE over a narrower wavelength than the gain bandwidth of the laser active material.

18. The ASE source of claim 17 in which the first lateral face is at a wedge angle with respect to the second lateral face, the first coating is on at least a portion of the first lateral face, and the second coating is on at least a portion of the second lateral face.

19. The ASE source of claim 17 in which the first lateral face is parallel to the second lateral face and the first coating is orientated at a wedge angle with respect to the second coating.

20. The ASE source of claim 17 in which the first coating is highly reflective over a broad wavelength band and the second coating is highly reflective over a different broad wavelength band overlapping the broad wavelength band of the first coating.

21. The ASE source of claim 20 in which the laser active material broad wavelength bandwidth is 100 nm or greater.

22. The ASE source of claim 21 in which the broad wavelength band of the first and second coatings is 80 nm or greater.

23. The ASE source of claim 22 in which the overlapping wavelength region is between 5 nm and 50 nm.

24. The ASE source of claim 17 in which the first and second coatings are highly reflective over a wavelength band narrower than the bandwidth of the laser active material.

25. The ASE source of claim 24 in which the narrow wavelength band is 3-10 nm.

26. The ASE source of claim 17 in which the broad bandwidth laser active material is Yb, Tm, Cr, Er, and/or Ho-doped gain materials.

27. A laser seed beam amplification method comprising:
choosing a broad bandwidth laser active material having a first lateral face spaced from a second lateral face;
directing at least one pump beam at the first lateral face;
directing a seed beam at one of the first and second lateral faces;
employing a first coating associated with the first lateral face highly reflective at the seed beam wavelength and highly transmissive at the pump beam wavelength;
employing a second coating associated with the second lateral face highly reflective at the seed beam wavelength; and
configuring the first and second coatings to provide gain of the seed beam over a narrower wavelength than the gain bandwidth of the laser active material.

28. The method of claim 27 including disposing the first lateral face at a wedge angle with respect to the second lateral face and wherein the first coating is on at least a portion of the first lateral face and the second coating is on at least a portion of the second lateral face.

29. The method of claim 27 in which the first lateral face is disposed parallel to the second lateral face and the first coating is orientated at a wedge angle with respect to the second coating.

30. The method of claim 27 in which the first coating is designed to be highly reflective over a broad wavelength band and the second coating is designed to be highly reflective over a different broad wavelength band overlapping the broad wavelength band of the first coating.

31. The method of claim 30 in which the laser active material broad wavelength bandwidth is chosen to be 100 nm or greater.

32. The method of claim 31 in which the broad wavelength band of the first and second coatings is designed to be 80 nm or greater.

33. The method of claim 32 in which the overlapping wavelength region is designed to be between 5 nm and 50 nm.

34. The method of claim 27 in which the first and second coatings are designed to be highly reflective over a wavelength band narrower than the bandwidth of the laser active material.

35. The method of claim 34 in which the narrow wavelength band is 3-10 nm.

36. The method of claim 27 in which the broad bandwidth laser active material is Yb, Tm, Cr, Er, and/or Ho-doped gain materials.
